(19) United States
(12) Patent Application Publication
(10) Pub. No.: US 2023/0114783 A1
(43) Pub. Date: Apr. 13, 2023

(54) APPLICATOR

(71) Applicant: NV Innovations, LLC, Vinton, IA (US)

(72) Inventor: Nicholas Rich, Vinton, IA (US)

(21) Appl. No.: 17/897,377

(22) Filed: Aug. 29, 2022

Related U.S. Application Data
(60) Provisional application No. 63/253,738, filed on Oct. 8, 2021.

(51) Int. Cl. A01G 25/02; A01G 25/09

(52) U.S. Cl. CPC A01G 25/026; A01G 25/09

(57) ABSTRACT

The invention includes systems and methods for applying liquids to the ground including an applicator with at least one conduit with at least one delivery outlet, and a support structure for the conduit where the conduit provides a fluid path to the delivery outlet from a liquid reservoir on a toolbar or agricultural machine. The systems and methods provide consistent placement of the liquids close to the stem of row crops, preferably within about 5 inches of the base of the stems. The systems and methods also provide this consistent placement over a variety of distances or lengths of the rows, including up to a mile in length. The systems and methods also allow for a variety of speeds for the application of liquids in this consistent manner.

### CLAIM OF PRIORITY

This application claims the benefit of U.S. Provisional Pat. Application 63253738, filed on Oct. 8, 2021, which is incorporated by reference.

### FIELD OF THE INVENTION

The present invention relates to systems and methods for applying liquids to row crops.

### BACKGROUND OF THE INVENTION

Application of liquid fertilizers, herbicides, and pesticides to row crops is difficult to do with precision; that is in close proximity to the stem of the plants. And precision is needed to reduce over application of such liquids. Over application results in wasting materials and potential environmental contamination. Known devices tend to be heavy and thus difficult to control; that is, difficult to maintain at an appropriate height above the ground. If the device is too low to the ground it risks damaging crops, particularly small crops (e.g. less than 16″ in height), while also causing mis-application because the device is misaligned with the crop. Known devices also tend to be fixed width meaning that liquids are only applied at set distances, leading to mis-application. Fixed width devices can also damage crops that are not within the set distance of the applicator.

### SUMMARY OF THE INVENTION

The systems and methods for applying liquids to the ground including an applicator with at least one conduit with at least one delivery outlet, and a support structure for the conduit where the conduit provides a fluid path to the delivery outlet from a liquid reservoir on a toolbar or agricultural machine. The systems and methods provide consistent placement of the liquids close to the stem of row crops, preferably within about 5 inches of the base of the stems. The systems and methods also provide this consistent placement over a variety of distances or lengths of the rows, including up to a mile in length. The systems and methods also allow for a variety of speeds for the application of liquids in this consistent manner.

### BRIEF DESCRIPTION OF THE DRAWINGS

FIG. 1 shows a plurality of applicators connected to a toolbar.

FIG. 2 shows one embodiment of an applicator in use.

FIG. 3 shows one embodiment of an applicator in use.

FIG. 4 shows an oblique view of a base.

FIG. 5 shows a view of a base from the perspective parallel with the connection rod portion of the support structure.

FIG. 6 shows a close up view of a delivery conduit connection receptacle on a base.

FIG. 7 shows a view of a base.

FIG. 8 shows a bottom view of a base with a connection conduit portion, a connection rod portion, a delivery conduit portion, and a delivery rod portion along with a protective cover.

### DETAILED DESCRIPTION

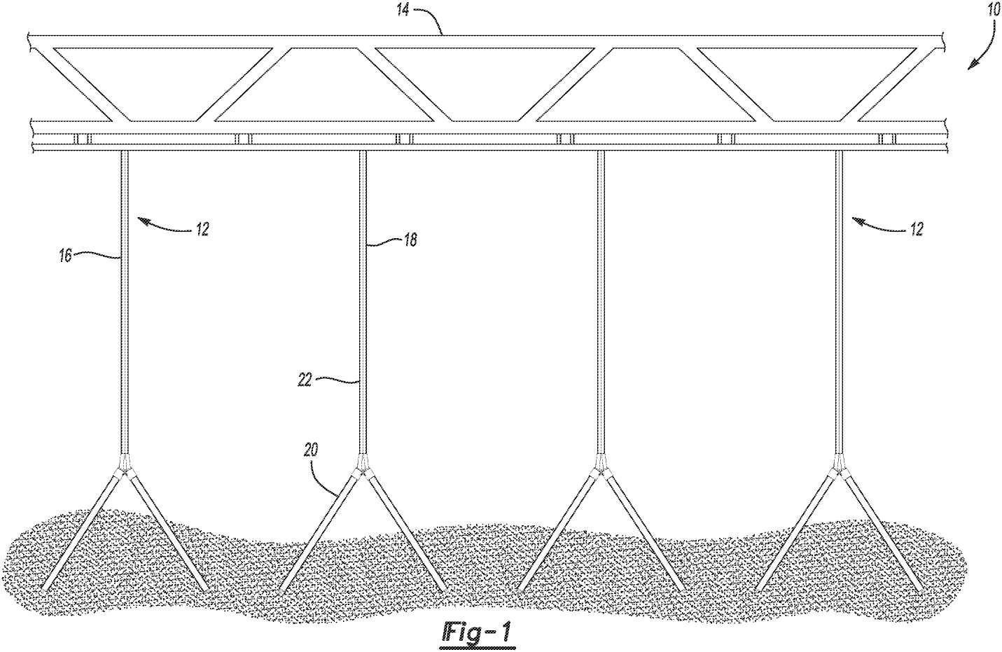

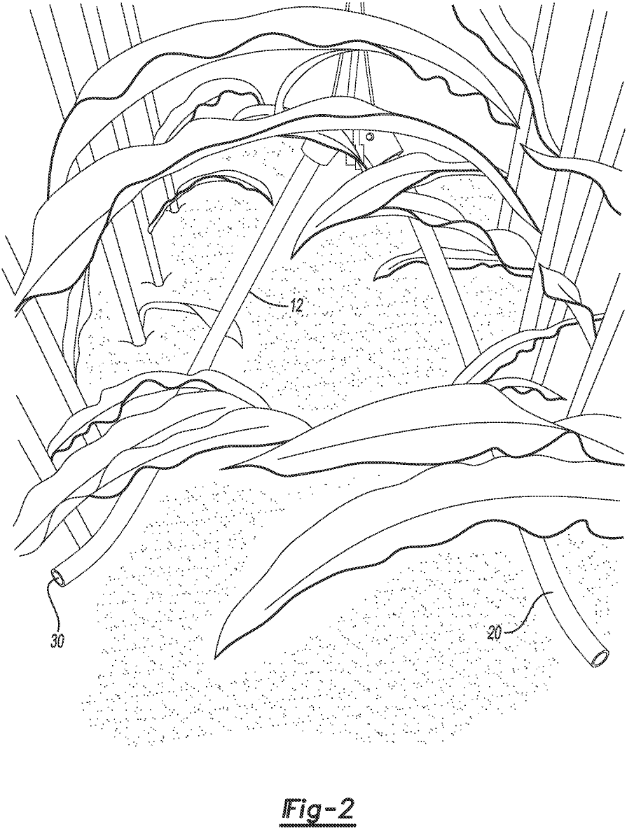

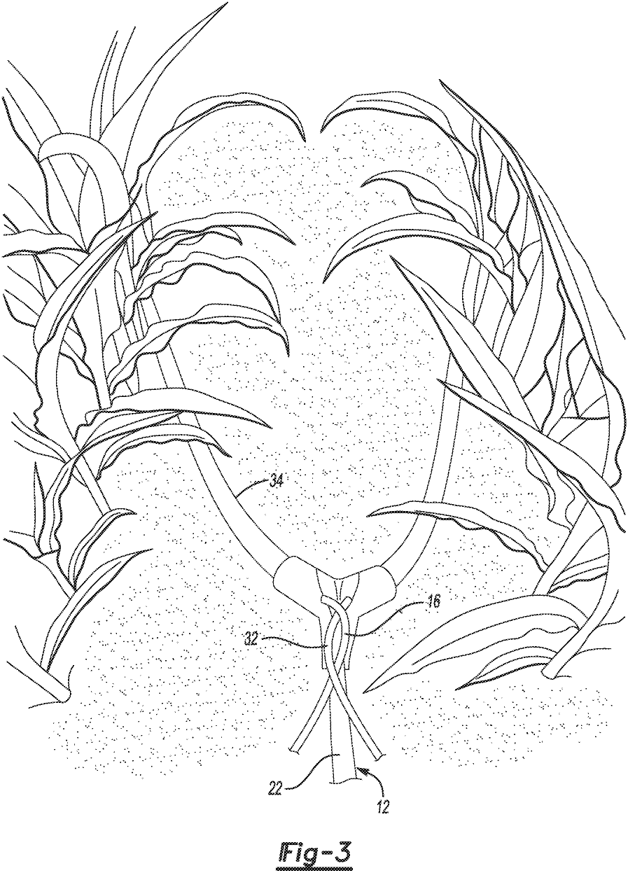

The present invention is a system that is easy to operate, and provides high speed and high accuracy application of liquids near the stem of row crops. The system is most useful from just after emergence until maturity of the crop, but may be used during planting, tilling, or harvesting as well. As seen in FIG. 1, the system 10 includes at least one and preferably a plurality of applicators 12, which in turn may be connected to a toolbar 14, which in turn may be connected to an agricultural machine (e.g. a tractor). FIGS. 2 and 3 show close up views of a single applicator as it is dragged along the ground to apply a liquid to two rows of crops at the same time.

As seen in FIGS. 1-3, 7, and 8, each applicator 12 includes at least one conduit 16, where the conduit 16 includes a connection portion 18 and a delivery portion 20. The applicator 12 also includes a support structure 22 for the conduit 16 which may include a connection rod portion 24, one or more delivery rod portions 26, and a base portion 28.

The conduit 16 provides a fluid conduit between the liquid reservoir and the delivery outlet 30 so that a liquid is provided to the delivery outlet during operation of the applicator. In one embodiment, the conduit 16 is formed from a unitary piece of piping or tubing. In another embodiment, the conduit 16 comprises two or more pieces fluidly connected together, for example a connection conduit 32 and a delivery conduit 34 connected via a base 28 or manifold 36.

The support structure 22 provides a separate mechanical connection to the toolbar 14 so as to reduce or eliminate the mechanical stress on the conduit(s) 16 and the fluid connection with the reservoir, while also assisting in transferring the weight of the conduits and support structure to the toolbar. The material of the support structure is not critical so long as it provides the desired reduction in mechanical stress and weight distribution. Similarly, while preferably less flexible than the conduit, the support structure has no required rigidity (or flexibility) so long as it provides the desired reduction in mechanical stress and weight distribution. The support structure also assists, during operation, in maintaining the delivery outlets in contact with the ground and thus close to the stems of the crops.

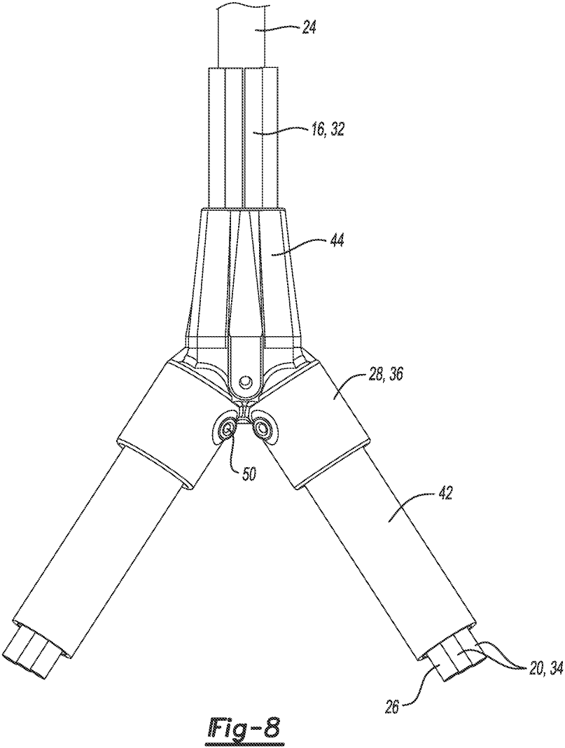

In one embodiment, the support structure 22 is a unitary structure. In another embodiment, the support structure comprises a connection rod 24, one or more delivery rods 26, and a base 28. In a preferred embodiment, the support structure comprises a connection rod, a base, and two delivery rods to form a Y-shaped structure, with the connection rod forming the leg and the delivery rods forming the arms, as seen in FIGS. 7 and 8. The applicator 12 preferably includes at least one conduit 16 for each delivery rod 26.

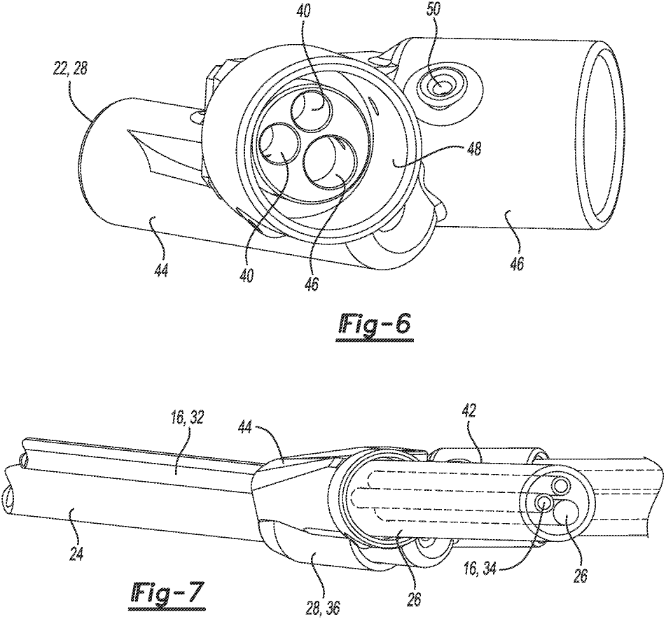

The conduit 16 is connected to the support structure 22 at one or more locations and using one or more connection methods. For the example, the connection or delivery portions of the conduit may be adhesively, mechanically fastened, snap-fit, or press-fit to the support structure. For example, the conduit may be held in snap-fit retainers on the support structure. Also, the conduit may pass through a hole 40 in the support structure 22 as a method of connecting the conduit to the support structure, as seen in FIGS. 5 and 6. As seen in FIG. 3, the hole in the base for the conduit may pass from the topside of the base into the interior of a receptacle on the base. Preferably, the conduit is connected to the support structure in at least two locations, one on the connection rod portion of the support structure, and one on the delivery rod portion of the support structure. The connection of the delivery portion of the support structure is preferably near the delivery outlet. In a more preferred embodiment, the conduit is at least connected to the base by passing through the hole in the base.

The material of the conduit is not critical but should be liquid impermeable, and may be selected to reduce the friction between the liquid and the conduit. Generally the conduit will be more flexible than the support structure. The conduit is tubular to allow liquid to flow through, and preferably has a circular cross-section, but may have other cross-sectional shapes as well.

The conduit 16 is generally co-extensive in length as the support structure 22, so that the delivery outlet 30 of the conduit is close to an end of the delivery rod portion of the support structure. However, the conduit and the support structure are not necessarily exactly co-extensive. Indeed, in a preferred embodiment, the conduit may extend past the end of the delivery rod portion of the support structure. The benefit of this format is that the conduit is preferably made of a more flexible material than the support structure and the conduit is thus less likely to damage crops that it comes into contact with during operation of the applicator.

The distance between the delivery outlets of a pair of delivery conduits is about the distance between the stems of the rows crops, and preferably slightly more than the distance between the stems of the row crops. With the slightly larger distance between the delivery outlets, in operation, the conduits will bump against the stems and be pushed away by the stems as the applicator(s) is dragged through the rows. That is, the stems will cause the distance between the delivery outlets to decrease as the conduits are pulled past the stems. This helps insure that liquid is always dispensed as close to the base of the stem as possible. This insures precise application of liquid to rows where the distance between the rows is uneven. The pressure exerted by conduits on the stems should be slight or minimal so as to avoid damaging the stems, even for recently emerged plants. The distance between the delivery outlets on the same applicator can be increased by forming the conduit and/or the delivery portion of the support structure into an arcuate shape, as best seen in FIG. 2. This would also reduce the amount of space taken up by the rest of the support structure and conduits. This assists in providing the delivery outlets as close to the stems as possible.

In preferred embodiments, the applicator(s) consistently applies liquid within 5 inches of the stem of the plants, within 4 inches of the stem of the plants, within 3 inches of the stem of the plants, within 2 inches of the stem of the plants, or within 1 inch of the stem of the plants, for the entire length of a row of plants where that row is at least 10 yards long, 25 yards long, 50 yards long, 100 yards long, 250 yards long, 500 yards long, 1000 yards long or 1760 yards long. For example, the applicator(s) consistently apply liquid within 4 inches of the plant stems for a distance of 100 yards or within 2 inches of the plant stems for a distance of 1000 yards. Each of these combinations of distance from the plant stem and the length of the row is contemplated.

In preferred embodiments, the applicator(s) can be moved, when in an operational position, across the ground with speeds up to 0.5 mph, 1.0 mph, 2.0 mph, 3.0 mph, 4.0 mph, 5.0 mph, 6.0 mph, 7.0 mph, 8.0 mph, 9.0 mph, or 10.0 mph, each within a range of plus or minus 0.1 mph or 0.25 mph. That is, when connected to a toolbar and/or agricultural machine, the applicators move through rows of crops at the disclosed speeds. The speeds may also be variable, whether in a set pattern or at the discretion of the operator of the system. In addition, each of these speeds in combination with distances from the plants and/or the row length is also contemplated.

In the embodiment where the conduit comprises two or more pieces fluidly connected together, the applicator 12 may include a manifold 36, as seen FIGS. 7 and 8. The manifold may be separate from, but is preferably part of the base portion 28 of the support structure. In this embodiment, the connection conduit 16 provides a fluid conduit between a liquid reservoir and the manifold 36 so that a liquid is provided to the manifold during operation of the applicator. A plurality of connection conduits 32 may be utilized to allow a plurality of liquids to be dispensed to one manifold, either simultaneously or sequentially. For example, two different liquids may be dispensed through different connection conduits of one applicator at the same time to one manifold. In the alternative, the two different liquids may be dispensed one after the other to one manifold, either through the same connection conduit(s) (where cross contamination is not a concern) or through separate connection conduits (where cross contamination is a concern).

The manifold includes one or more manifold inlets and one or more manifold outlets, where the manifold provides a fluid conduit between the connection conduits 32 and the one or more delivery conduits 34. The inlets and outlets of the manifold may be the same as the through holes in the base, so that separate conduits may be connected to the base and the base operates as a manifold, whether the support structure is a unitary construction or made of several components.

Preferably, the manifold serves to divide the liquid received from the connection conduit into separate streams, such that a portion of the liquid flows to each delivery conduit. Preferably, the manifold has at least one inlet and at least two outlets associated with each inlet. Embodiments with only one outlet for each inlet are also contemplated, particularly situations where liquid is being applied on the outside of the last row in a field. A preferred type of manifold includes the ability to dispense two different liquids without the need for cleaning the applicator between liquid applications. That is, the manifold includes two inlets, where each inlet is associated with a pair of outlets and delivery conduits. For example, liquid A is dispensed to a first inlet in the manifold, which is then separated between a pair of first outlets and first delivery conduits, while liquid B is dispensed to a second inlet in the manifold, which is then separated between a pair of second outlets and second delivery conduits.

The overall length of each applicator is not critical; rather the combination of the conduit and support structure should be such that the applicators installed on the same toolbar are generally that same length. This will help insure that, at a given height of the toolbar above the ground, all the applicators will be similarly situated with respect to the ground and with respect to the row crops to which liquid is being dispensed. Indeed, the overall length of the applicator may be dictated by the vertical movement of the toolbar to which the applicators are connected.

The applicator may include a protective sleeve 42 that covers some or all of the conduit and support structure. The protective sleeve generally provides the covered components with additional resistance to wear-and-tear as well as additional resistance frictional forces, as well as serving to connect the conduit(s) to the support structure. An integrated protective sleeve may be used to cover multiple components, or separate protective sleeves may be used with individual components.

In one embodiment, a protective sleeve 42 is used to cover the conduit and the support structure over the entire length of between the toolbar and the delivery outlet, or just a portion of the length of the distance between the toolbar and the delivery outlet. In one embodiment, a protective sleeve covers some or all of the connection portion of the conduit and the corresponding portion of the support structure. In this manner, the protective sleeve connects the conduit to the support structure. In one embodiment, the protective sleeve may be received in a receptacle or otherwise mechanically fastened to the base. For example, a protective sleeve receptacle 48 in the base is seen in FIG. 6. In another embodiment, a protective sleeve covers some or all of the delivery portion of the conduit and the corresponding portion of the support structure. Again, the protective sleeve connects the conduit to the support structure. Similar to above, the protective sleeve for the delivery portion of the conduit may be received in a receptacle or otherwise mechanically fastened to the base.

For embodiments where the support structure is not a unitary construction, the components may be fitted together and then fastened to each other, either adhesively or mechanically. For example, as seen in FIGS. 5-8, the connection rod 24 may be fitted to a receptacle 44 on the base and fastened with a fastener in fastener through hole 50. Similarly, the delivery rod 26 may be fitted to another receptacle 46 on the base and fastened with a fastener in through hole 50. In addition to mechanical fasteners (such as screws, nuts and bolts, or pins and bushings), the connection between the components of the support structure may be snap-fit or press-fit. One benefit of a support structure that is not a unitary construction is that the materials of the components can be selected to better match the desired characteristics of that portion of the support structure. For example, the connection and delivery rods are preferably flexible, while the base is rigid.

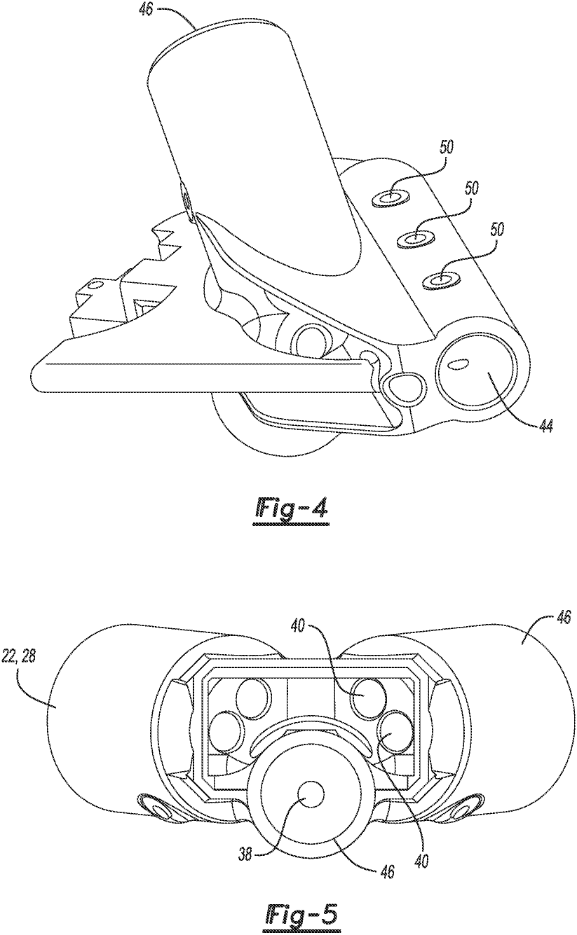

As seen in FIG. 5, in one preferred embodiment, a fastener through hole 38 in the base for connection of the connection rod to the base accepts a mechanical fastener where the major axis of the connection rod and the mechanical fastener are parallel to each other, although they may be perpendicular or some other angle. As seen in FIGS. 4, 6, and 8, in one preferred embodiment, a fastener through hole 50 in the base for connection of the delivery rods to the base accepts a mechanical fastener where the major axis of the delivery rod and the mechanical fastener are perpendicular to each other, although they may be parallel or some other angle.

The mechanical fastener (or other connection method) used to connect the protective sleeve to the base may also be used to connect the connection rod to the base. Similarly, the mechanical fastener (or other connection method) used to connect the protective sleeve to the base may also be used to connect the delivery rod to the base.

A toolbar is utilized to connect the applicator(s) to an agricultural machine. A variety of known toolbars, including those with booms, may be used. Booms are those that may be moved between a storage position and an operational position (e.g. folded-up and folded-down), as well as raised and lower above the ground. The number of applicators connected to a toolbar is limited only by the size of the toolbar. Thus it is contemplated that at least 2, 4, 6, 8, 10, 12, 14, 16, 18, or 20 applicators may be used on a single toolbar, especially if booms are also utilized. Agricultural machines include land vehicles that are driver-operated, remotely operated, and autonomously operated vehicles, and may be self-propelled or towed by another vehicle (e.g. a trailer).

The manner of connection of the applicator(s) to the toolbar is not critical and may include mechanical, snap-fit, and press fit connections, as well as jointed connections, provided the connection type is strong enough to maintain the applicator connection to the toolbar while the applicator is dragged across the ground.

Typically, the liquid reservoir is one of a plurality of reservoirs carried on the toolbar or a central reservoir carried on the agricultural machine or a trailer. In one embodiment, one or more pumps are utilized to dispense the liquid from the reservoir to the applicator. In another embodiment, the reservoir is positively pressurized so that liquid is dispensed from the reservoir during operation (e.g. via opening a valve). In another embodiment, liquid is dispensed from the reservoir because of a syphon effect.

A plurality of different liquids may be held in separate reservoirs and dispensed to the applicators. In one embodiment, one conduit on an applicator may be utilized to apply two liquids, either simultaneously or sequentially. For applicators with multiple conduits, differing liquids (or sets of liquids) may be applied by different conduits connected to a single support structure. In another embodiment, differing liquids (or sets of liquids) may be applied by different applicators connected to a single toolbar.

The system may be operated in response to feedback from one or more sensors located on the applicator, toolbar, the agricultural machine, or remote sensors (e.g. GPS or soil moisture sensors). Such operation of the system may be according to a site plan (e.g. a fertilizer application plan). And such operation may be automatic (without operator intervention) or manually by the operator of the applicator, toolbar, or agricultural machine, whether by wireline or wirelessly.

The system may include one or more valves for controlling the flow of liquid through the system. For example, from the reservoir to the conduits or through the manifold to the delivery conduit(s). When valves are associated with the reservoir, such valves may be integral to the reservoir, or located in the fluid connection between the reservoir and the conduit. When valves are associated with one or more of the manifolds, such valves may be integral to the manifold, or located in the fluid connection between the connection conduit and the manifold, or between the manifold and the delivery conduit. It is also contemplated that valves may be used at or near the delivery outlet.

In operation, the toolbar, with the applicators connected, is moved (e.g. lowered) into an operational position when the agricultural machine arrives at the location (e.g. in the field) where liquid dispensing is to begin. Before liquid is passed from the reservoir(s), the toolbar is moved so that at least a portion of the conduit(s) is close to or in contact with the ground such that the delivery outlet(s) is at or near the base of the stem of the row crop. The toolbar, however, preferably is far enough above ground so that the connection rod portion and the base of the support structure do not come in contact with the ground during operation. This minimizes wear-and-tear on the support structure, and minimizes friction between the applicator and the ground. The amount of the conduit in contact with the ground is adjusted by raising or lowering the toolbar connected to the agricultural machine, again with an aim of minimizing friction between the conduits and the ground, while maintaining the delivery outlets in close proximity to where the plant stems emerge from the ground. Overall, the minimized friction between the applicator and the ground helps to achieve increased speed of the agricultural machine, which in turn reduces the amount of time needed to apply liquid to a given acreage.

In one operational embodiment, the toolbar is lowered so that the delivery conduits are in contact with the ground and such that, at least the delivery rods, are slightly flexed (the connections rods may also be flexed, but not necessarily). The flexed delivery rods will push against the ground to maintain a consistent position of the outlets of the delivery conduits vis a vis the ground level. The distance from the lower ends of the lower rods is wider than the rows of crop. When the device is moving through the crops the lower rods flex towards each other putting light pressure against the stems of the rows of crops. This helps stabilize the device and center it between the rows as it moves through the field.

The method includes flowing liquid through the conduit to the delivery outlet of one or more of the applicators. The method may be accomplished through the operation of the system as discussed above.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

### REFERENCE NUMERALS

10 System
12 Applicator
14 Toolbar
16 Conduit
18 Connection portion
20 Delivery portion
22 Support structure
24 Connection rod portion, connection rod
26 Delivery rod, delivery rod portion
28 Base portion, base
30 Delivery outlet
32 Connection conduit
34 Delivery conduit
36 Manifold
38 Fastener through hole
40 Hole
42 Protective sleeve
44 Connection rod receptacle
46 Delivery rod receptacle
48 Protective sleeve receptacle
50 Fastener through hole

What is claimed is:

1. A system for applying liquids comprising an applicator having:
at least one conduit having at least one delivery outlet,
a support structure connected to the at least one conduit, and
wherein the conduit provides a fluid path to the at least one delivery outlet.

2. The system of claim 1 wherein the support structure comprises at least two delivery portions for each connection portion.

3. The system of claim 2 further comprising at least two conduits, one for each of the at least two delivery portions.

4. The system of claim 3 wherein the at least two conduits are connected to the support structure at hole in the support structure.

5. The system of claim 4 wherein the conduit is connected to the support structure at least at a hole through the support structure.

6. The system of claim 5 wherein the support structure is a unitary construction.

7. The system of claim 5 wherein the support structure comprises at least two components connected together.

8. The system of claim 7 wherein the support structure comprises at least one connection rod, at least two delivery rods, and a base connected to the at least one connection rod and the at least two delivery rods.

9. The system of claim 8 wherein the base comprises one or more receptacles to receive one or more connection rods, one or more delivery rods, or one or more protective sleeves.

10. The system of claim 1 wherein the at least one conduit is arcuate in a delivery portion of the conduit.

11. The system of claim 2 wherein each conduit of the at least one conduit comprises a connection conduit, at least two delivery conduits, and a manifold fluidly connecting the at least one connection conduit to the at least two delivery conduits.

12. The system of claim 1 further comprising a protective sleeve covering at least a portion of the at least one conduit, or at least a portion of the at least one conduit and the support structure.

13. The system of claim 1 comprising a plurality of applicators.

14. The system of claim 13, wherein the plurality of applicators are adapted to apply liquid within 5 inches of stems of a plurality of plants in a row, within 4 inches of stems of a plurality of plants in a row, within 3 inches of stems of a plurality of plants in a row, within 2 inches of stems of a plurality of plants in a row, or within 1 inch of stems of a plurality of plants in a row, for an entire length of the row plants.

15. The system of claim 14, wherein the length of the row is at least 10 yards long, 25 yards long, 50 yards long, 100 yards long, 250 yards long, 500 yards long, 1000 yards long or 1760 yards long.

16. The system of claim 13, wherein the applicators are adapted to be moved across the ground, when in an operational position, at speeds up to 0.5 mph, 1.0 mph, 2.0 mph, 3.0 mph, 4.0 mph, 5.0 mph, 6.0 mph, 7.0 mph, 8.0 mph, 9.0 mph, or 10.0 mph.

17. A method of applying liquid to the ground, comprising:
flowing at least one liquid through at least one applicator comprising at least one conduit, connected to a support structure, to a delivery outlet.

18. The method of claim 17 wherein the flowing step comprises flowing the at least one liquid through a plurality of applicators.

19. The method of claim 18 wherein the flowing step comprises flowing the at least one liquid wherein the delivery outlet of each of the at least one conduits remains within 5 inches of stems of a plurality of plants in a row, within 4 inches of stems of a plurality of plants in a row, within 3 inches of stems of a plurality of plants in a row, within 2 inches of stems of a plurality of plants in a row, or within 1 inch of stems of a plurality of plants in a row, for an entire length of the row plants.

20. The method of claim 19, wherein the flowing step comprises flowing the at least one liquid through the applicator when the applicator is being moved across the ground, when in an operation position, at speeds up to 0.5 mph, 1.0 mph, 2.0 mph, 3.0 mph, 4.0 mph, 5.0 mph, 6.0 mph, 7.0 mph, 8.0 mph, 9.0 mph, or 10.0 mph.
